(19) United States
(12) Patent Application Publication
(10) Pub. No.: US 2024/0359688 A1
(43) Pub. Date: Oct. 31, 2024

(54) VEHICLE CONTROL SYSTEM AND VEHICLE CONTROL METHOD

(71) Applicant: YAZAKI CORPORATION, Tokyo (JP)

(72) Inventors: Aya Hashimoto, Susono-shi (JP); Takeyoshi Watanabe, Susono-shi (JP); Koichiro Ono, Susono-shi (JP); Shinichi Okamoto, Susono-shi (JP)

(21) Appl. No.: 18/635,562

(22) Filed: Apr. 15, 2024

(30) Foreign Application Priority Data
Apr. 26, 2023 (JP) 2023-072687

(51) Int. Cl. B60W 30/14; B60W 10/18; B60W 30/16; B60W 30/18; B60W 50/14

(52) U.S. Cl. CPC B60W 30/146; B60W 10/18; B60W 30/162; B60W 30/18163; B60W 50/14; B60W 2050/143; B60W 2050/146; B60W 2710/18; B60W 2720/106; B60W 2754/30

(57) ABSTRACT

A vehicle control system includes a communication control unit for controlling cooperation between a user terminal used by a user who is capable of moving by using a user vehicle and a photographer terminal used by a photographer who is capable of photographing the user with a camera, and a vehicle control unit such as a service dedicated application capable of controlling the user vehicle. When a subject vehicle approaches a photographing position of the photographer, the vehicle control unit changes a traveling state of the subject vehicle to a traveling state that is easy to see from the photographer.

### CROSS-REFERENCE TO RELATED APPLICATIONS

This application is based on and claims priority under 35 USC 119 from Japanese Patent Application No. 2023-072687 filed on Apr. 26, 2023, the contents of which are incorporated herein by reference.

### TECHNICAL FIELD

The present invention relates to a vehicle control system and a vehicle control method that can be used when a photographer outside a vehicle takes a photo or the like of a user who uses the vehicle.

### BACKGROUND ART

For example, Patent Literature 1 discloses a technique for achieving a service for mediating between a person (photo applicant) who wants to take a photo and a person (photographer) who takes the photo. Further, as described in paragraph of Patent Literature 1, the server 1 can extract the photographer 5 present in the vicinity of each photo applicant 2 using the logged user position information and photographer position information, transmit the information of the photographer 5 to the user device 3 as surrounding photographer information, and the user device 3 can display the information of the photographer 5 present in the vicinity. Further, the photo applicant 2 can know whether there is a possibility that a photo is taken at this place.

### CITATION LIST

### Patent Literature

Patent Literature 1: JP2019-16100A

### SUMMARY OF INVENTION

For example, it is considered that people such as tourists who visit various tourist sites in a trip often want to create a diary including photos at the tourist site where the tourists appear in order to leave a reminiscence of the trip. Further, since traffic is often inconvenient in a tourist site, it is considered that each tourist has many opportunities to borrow a vehicle such as a rental car on site and to travel the tourist site while driving the vehicle by himself or herself.

Therefore, when each tourist takes a photo of the tourist himself or herself at each place, it is assumed that there are many scenes such as a state in which the tourist himself or herself drives the vehicle and travels, a state in which the tourist himself or herself gets on and off the vehicle, and a state in which the tourist looks at a vicinity of the rental car borrowed by the tourist himself or herself.

However, particularly in the state in which the tourist himself or herself drives the vehicle, himself or herself cannot take a photo of himself or herself. Here, for example, it is conceivable that a tourist who wants to perform photographing may have a photo thereof taken by a photographer on site by using a service such as the technique in Patent Literature 1.

However, if it is assumed that any photographer outside the vehicle takes a photo of a driver or other passengers in the vehicle while the vehicle is running, the following problems may occur, for example.

(1) In a case on which a vehicle in which a target person (tourist) having a desire of being photographed occupies approaches a position of a photographer outside the vehicle in a state in which a traveling speed of the vehicle is too fast, failures in positioning of a camera which performs photographing and a photographic subject, adjustment of an angle of view, focusing, or adjustment of a photographic timing is likely to occur, and there is a possibility that the tourist cannot be well photographed.

(2) When a plurality of vehicles travel in the same direction on the same road in a row, it is difficult for the photographer to distinguish which of the plurality of vehicles is a target vehicle on which the person having a desire of being photographed occupies.

(3) In a case in which another vehicle (preceding vehicle) is present in front of the target vehicle on which the person having a desire of being photographed occupies, there is a high possibility that a photo of a state in which the preceding vehicle appears together with the target vehicle is taken. Here, when the preceding vehicle is not related to the tourist site, the preceding vehicle in the photo is regarded as unnecessary noise for the person having a desire of being photographed, and thus a value of the photo is further reduced due to the preceding vehicle.

(4) In a case in which a photographer outside the vehicle performs photographing while the person having a desire of being photographed drives the vehicle, when the person having a desire of being photographed does not recognize a position of the photographer, a photographing position, or the like in advance, there is a high possibility that a photo is taken in a state in which a direction of the face of the person having a desire of being photographed is not suitable for the photographing. As a result, a value of the taken photo decreases.

(5) In a case in which a photographer outside the vehicle performs photographing while the person having a desire of being photographed drives the vehicle, the person having a desire of being photographed is likely to look around while driving the vehicle to search for the photographer, and it is difficult to maintain a safer driving state for inattentive driving.

The present invention has been made in view of the above circumstances, and an object of the present invention is to provide a vehicle control system and a vehicle control method which are useful for a photographer outside a vehicle to easily take a photo which is more valuable for a person having a desire of being photographed, when the photographer uses a camera to photograph the person having a desire of being photographed in the vehicle.

The above object according to the present invention is achieved by the following configuration.

(1) A vehicle control system includes a communication control unit that controls cooperation between a first communication terminal used by a specific person who is capable of moving by using a vehicle and a second communication terminal used by a photographer who is capable of photographing the specific person with a camera, a vehicle control unit that controls a specific vehicle associated with the specific person. The vehicle control unit has a traveling state changing function of generating an instruction for changing a traveling state of a subject vehicle to a traveling state that is easy to see from the photographer when the subject vehicle approaches a photographing position of the photographer.

(2) A vehicle control method includes securing a communication path so as to enable cooperation between a first communication terminal used by a specific person who can move by using a vehicle and a second communication terminal used by a photographer who can photograph the person with a camera; grasping a positional relationship between a subject vehicle and a photographing position of the photographer; and generating an instruction to change the subject vehicle to a traveling state easy to see from the photographer when the subject vehicle approaches the photographing position of the photographer.

According to the vehicle control system and the vehicle control method of the present invention, when the photographer outside the vehicle photographs, with a camera, the person having a desire of being photographed in the vehicle, the photographer can easily take a photo which is more valuable for a person having a desire of being photographed. That is, it is possible to change the traveling state to a traveling state that is easy to see from the photographer, such as moving the vehicle to a position that is easy to see from the photographer or reducing the traveling speed, when the vehicle on which the person wishing to photograph approaches the photographing position of the photographer. Furthermore, by reducing the running speed of the vehicle, improvement in driving safety at the time of photographing can also be expected.

The present invention has been briefly described above. Further, details of the present invention can be clarified by reading modes (hereinafter, referred to as “embodiments”) for carrying out the invention described below with reference to the accompanying drawings.

### BRIEF DESCRIPTION OF DRAWINGS

FIG. 1 is a block diagram showing an outline of a configuration of a photography management system including a vehicle control system according to the present invention;

FIG. 2 is a plan view showing an example of a positional relationship between a service user and a photographer;

FIG. 3 is a block diagram illustrating a functional configuration example of a main part in the vehicle control system;

FIG. 4 is a flowchart illustrating an operation example of the vehicle control system;

FIG. 5 is a flowchart illustrating an operation of the vehicle control system according to a modification;

FIG. 6 is a plan view illustrating a screen display example 1 on a service user side;

FIG. 7 is a plan view illustrating a screen display example 2 on the service user side; and

FIG. 8 is a plan view illustrating a screen display example 3 on the service user side.

### DESCRIPTION OF EMBODIMENTS

Specific embodiments of the present invention will be described below with reference to the drawings.

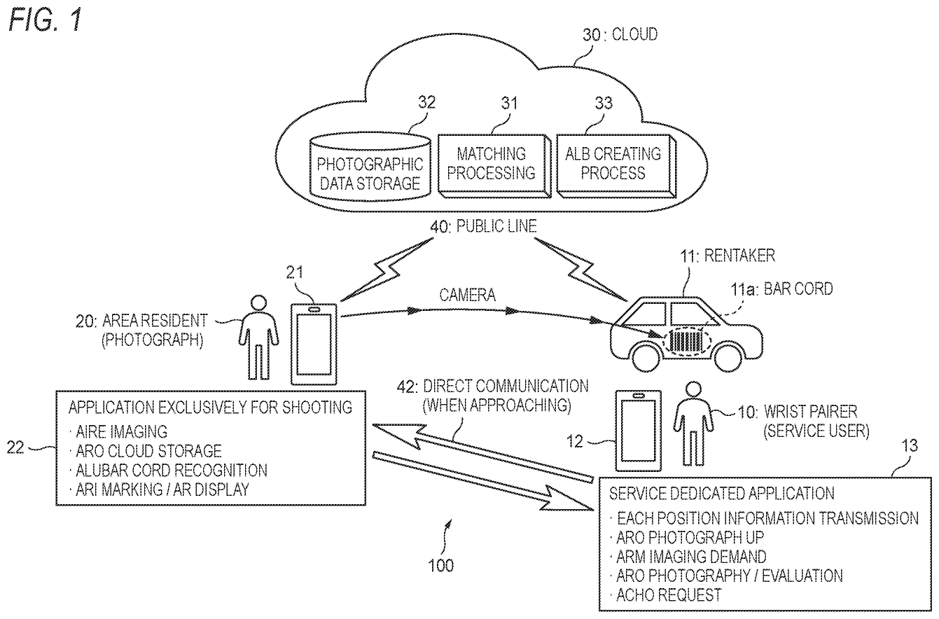

FIG. 1 shows an outline of a configuration of a photography management system 100 including a vehicle control system of the present invention.

The photography management system 100 shown in FIG. 1 includes a user terminal 12 used by a service user 10, a photographer terminal 21 used by a photographer 20, and a cloud 30 that provides main functions of a management service.

In the example shown in FIG. 1, the service user 10 is a tourist who goes sightseeing at a tourist site, and uses a user vehicle 11 as a device for traveling various locations of the tourist site. The user vehicle 11 is, for example, a rental car, and a bar code 11a capable of distinguishing each vehicle is added to an outer surface of a vehicle body. Information on the bar code 11a can be optically read using a camera or the like.

Further, the photographer 20 is, for example, a normal local resident who lives at various locations of the tourist site, or a professional photographer who happens to be at the location.

The user terminal 12 is, for example, a smartphone, and is equipped with various communication functions, a camera, a display, various input devices, a global positioning system (GPS) receiver, a control unit (CPU), a storage device, and the like as in a general smartphone.

A service dedicated application 13 that uses functions of the cloud 30 is incorporated in the user terminal 12 in advance. The service dedicated application 13 has functions such as position information transmission, photograph up, photographing request, photo viewing/evaluation, and album request.

For example, when the service user 10 travels using the user vehicle 11, the service user 10 can transmit a service request for allowing any photographer 20 to take a photo of the service user 10 to the cloud 30 using the user terminal 12 and the service dedicated application 13.

The photographer terminal 21 used by the photographer 20 is, for example, a smartphone, and is equipped with various communication functions, a camera, a display, various input devices, a GPS receiver, a control unit, a storage device, and the like as in a general smartphone.

Further, a photographing dedicated application 22 for the photographer 20 to use the functions of the cloud 30 is incorporated in the photographer terminal 21 in advance. The photographing dedicated application 22 has a positional information transmission function, a photo taking function, a cloud storage function of taken photos, a bar code recognition function, a marking/augmented reality (AR) display function, and the like.

On the other hand, the cloud 30 is implemented by, for example, application software (application) incorporated in a server device installed in a predetermined data center. The server device has a function of communicating with the user terminal 12 and the photographer terminal 21 via a public communication line 40. The cloud 30 according to the present embodiment includes a matching processing unit 31, a photo data storage unit 32, and an album creation processing unit 33.

The matching processing unit 31 has a processing function necessary for implementing smooth matching for taking a photo between the service user 10 who wants to take a photo and the photographer 20 at each location registered in advance. The photo data storage unit 32 can store data such as a photo taken by the photographer 20. The album creation processing unit 33 implements processing for creating a photo album.

<Positional Relationship between Service User and Photographer>

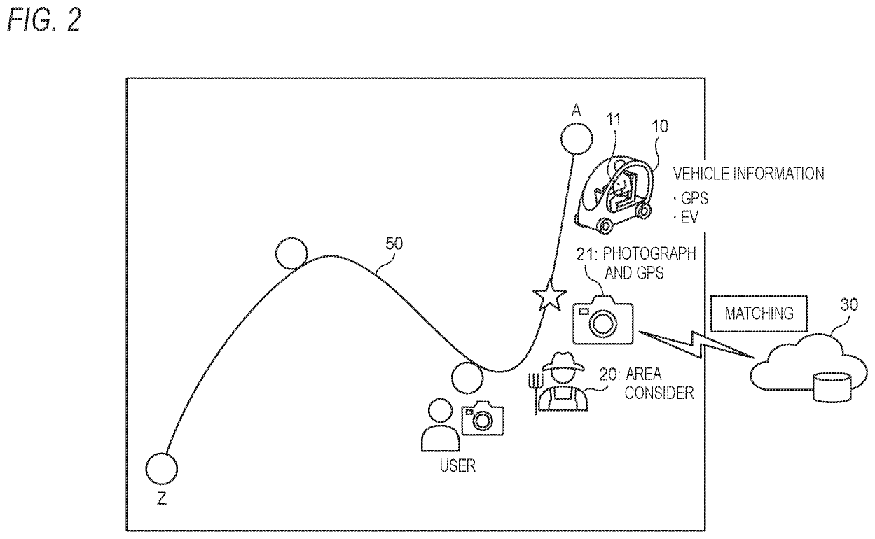

FIG. 2 shows an example of a positional relationship between the service user 10 and the photographer 20.

The service user 10 uses the user vehicle 11 such as a rental car as shown in FIG. 2, and travels on a road 50 while going sightseeing from a point A to a point Z. At each point on the road 50 on the way of traveling, there is a possibility that the service user 10 may request to take a photo as reminiscence.

In a tourist site or the like, there is a possibility that a local resident or the like is present in each site as the photographer 20. The photographer terminal 21 held by each photographer 20 has a function of a camera that takes a photo as a smartphone, a function of grasping a current position of the photographer by GPS, a function of communicating with the cloud 30, and the like.

When the service user 10 wants to take a photo, the service user 10 operates the service dedicated application 13 of the user terminal 12, so that a request for photo taking can be transmitted to the cloud 30 together with position information of the vehicle of the service user 10.

Since the current positions of the photographer 20 present at the points are grasped, the matching processing unit 31 of the cloud 30 can match each service user 10 with the specific photographer 20 by using the current position of the user vehicle 11 of the service user 10 who has sent the request for photo taking, the current position of each photographer 20, information of a road map, and the like.

For example, the matching processing unit 31 of the cloud 30 automatically controls lighting of interior lighting, a headlamp, and the like in the specific user vehicle 11 of the service user 10, so that the photographer 20 can more easily visually check the user vehicle 11 to be photographed.

As shown in FIG. 1, the photographer 20 can read the bar code 11a on the user vehicle 11 by the camera of the photographer terminal 21 and transmit information on the bar code 11a from the photographer terminal 21 to the cloud 30.

Since the matching processing unit 31 of the cloud 30 grasps the information on the bar code 11a of the user vehicle 11 in advance, by comparing this information with the information on the bar code 11a transmitted by the photographer 20, it is possible to identify whether the vehicle as a photographic subject to which the camera of the photographer 20 is faced matches the user vehicle 11 of the service user 10.

Based on the information transmitted from the matching processing unit 31, the photographing dedicated application 22 on the photographer terminal 21 adds marking information to the user vehicle 11 as a photographing object on the display of the photographer terminal 21, and executes an AR display in a state where a video of the user vehicle 11 as the photographic subject and the marking information are superimposed. With this AR display, the photographer 20 can easily photograph the service user 10 without making a mistake on the vehicle as the photographing object.

Each of the user terminal 12 and the photographer terminal 21 normally accesses the cloud 30 using the public communication line 40 and is in a communication state via the cloud 30. On the other hand, when a distance between the user terminal 12 and the photographer terminal 21 is short, direct communication 42 without relaying in the cloud 30 may be performed.

On the other hand, when the photographer 20 actually photographs the user vehicle 11 and the service user 10 that are in traveling, a more clear photo may not be taken due to various factors. For example, when photographing is performed in a state in which a traveling speed of the user vehicle 11 is too fast, failures in photographing timing, positioning, focusing, light amount adjustment, and the like are likely to occur. Further, in a case in which another preceding vehicle travels in front of the user vehicle 11 as the photographing object, when an inter-vehicle distance between the user vehicle 11 and the preceding vehicle is short, there is a high possibility that the preceding vehicle is simultaneously photographed in a state of blocking the user vehicle 11, and quality of the taken photo deteriorates.

The photography management system 100 according to the present embodiment is equipped with a vehicle control system for implementing an appropriate photography environment by cooperation between the cloud 30 and the user vehicle 11. For example, when the user vehicle 11 approaches a place where the photographing is to be performed, an accelerator operation is limited or an automatic braking operation is implemented, so that the traveling speed of the user vehicle 11 does not become high. Alternatively, a driver of the user vehicle 11 is guided by display, voice, or the like, so that the driver of the user vehicle 11 drives in the above manner. When the inter-vehicle distance between the user vehicle 11 and the preceding vehicle is short, the inter-vehicle distance is controlled to be large. Details will be described later.

### <Functional Configuration of Main Part in System>

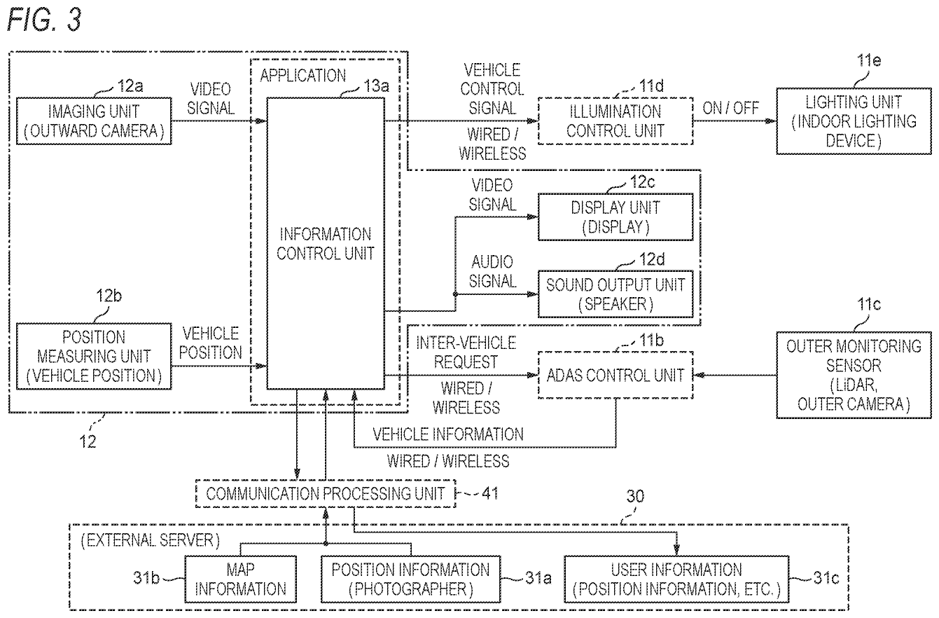

FIG. 3 shows a functional configuration example of a main part in the vehicle control system according to the embodiment.

The vehicle control system shown in FIG. 3 includes a photographing unit 12a, an own vehicle position measurement unit 12b, a display unit 12c, and a sound output unit 12d as functions on the user terminal 12. Further, the service dedicated application 13 includes an information control unit 13a. Further, an ADAS control unit 11b, a vehicle exterior monitoring sensor 11c, a light control unit 11d, and a lighting unit 11e are provided in the user vehicle 11.

Each of the photographing unit 12a, the own vehicle position measurement unit 12b, the display unit 12c, the sound output unit 12d, and the information control unit 13a may also use functions provided in the user vehicle 11.

The photographing unit 12a is an outward-facing camera, and is disposed in such a manner that the photographing unit can photograph a road or the like in a forward direction of travel from inside a cabin of the user vehicle 11 to outside the vehicle as a photographic subject. The own vehicle position measurement unit 12b can, for example, periodically output latitude/longitude information representing the current position of the user vehicle 11, which is determined using, for example, GPS.

The display unit 12c can display a video signal output by the service dedicated application 13 as a substantially real-time video so that the service user 10 can see the substantially real-time video. Specifically, as will be described later, a screen including a road map, the location of the photographer 20, and the like is displayed on the display unit 12c.

The sound output unit 12d can output a sound signal output by the service dedicated application 13 as a sound or voice by a speaker. Specifically, for example, sound guidance indicating that the user vehicle 11 has approached the photographing position of the specific photographer 20 can be output so that the service user 10 can hear the sound guidance.

The service dedicated application 13 can acquire information on the current location of each photographer 20 from a location information processing unit 31a of the cloud 30 via a communication processing unit 41. The service dedicated application 13 can acquire information on the current position of the own vehicle from the own vehicle position measurement unit 12b. Further, the service dedicated application 13 can acquire the information of the road map from a map information processing unit 31b of the cloud 30. The service dedicated application 13 can acquire, from the photographing unit 12a, a video equivalent to a scene in front of the driver or the like of the own vehicle. Further, the service dedicated application 13 can transmit a user information including location information of the service user 10 to a user information processing unit 31c of the cloud 30.

The information control unit 13a of the service dedicated application 13 compares a latest own vehicle position acquired from the own vehicle position measurement unit 12b with the position information of the photographer 20 acquired from the position information processing unit 31a, and monitors a distance therebetween and a change in distance. Further, when the information control unit 13a detects the preceding vehicle in front of the own vehicle from the video captured by the photographing unit 12a, the information control unit 13a grasps a magnitude of the inter-vehicle distance between the own vehicle and the preceding vehicle.

The information control unit 13a generates the video signal of a necessary screen, the sound signal of the sound guidance, or a signal of an inter-vehicle request for increasing the inter-vehicle distance, according to a monitoring state of a distance. The video signal, the sound signal, and the signal of the inter-vehicle request which are generated by the information control unit 13a are input to the display unit 12c, the sound output unit 12d, and the ADAS control unit 11b, respectively.

Further, the information control unit 13a generates a vehicle control signal when a predetermined condition is satisfied based on the distance between the own vehicle position and the photographer 20 and respective positions. The vehicle control signal is input to the light control unit 11d in order to control the turning on and off of the lighting unit 11e on the user vehicle 11 side.

On the other hand, the advanced driver-assistance systems (ADAS) control unit 11b provided in the user vehicle 11 can grasp a situation of the user vehicle 11 by using the vehicle exterior monitoring sensor 11c including a LiDAR, a camera that photographs an outside of the vehicle, or the like, and perform various driving assistance. Specifically, the ADAS control unit 11b can automatically perform a brake operation, an accelerator operation, a steering operation, and the like depending on the situation of the vehicle, or present driver assistance guidance through a sound, display, or the like such that the driver performs an appropriate driving operation.

In the present embodiment, when the photographer 20 outside the vehicle takes a photo of the user vehicle 11 or the service user 10 driving the user vehicle 11, the service dedicated application 13 can input the signal of the inter-vehicle request to the ADAS control unit 11b. Accordingly, in the case of taking the photo, the ADAS control unit 11b can automatically prevent the accelerator operation or automatically apply the brake so as to reduce the vehicle speed so that the inter-vehicle distance becomes larger than that in a normal driving condition.

The light control unit 11d can control the turning on and off of an interior light device provided in the lighting unit 11e of the user vehicle 11. In the present embodiment, the vehicle control signal generated by the service dedicated application 13 is input to the light control unit 11d via a wired or wireless communication path. Further, information from the vehicle exterior monitoring sensor 11c is input to the service dedicated application 13 via a wired or wireless communication path. Therefore, the service dedicated application 13 can control interior lighting of the user vehicle 11 or the like as necessary.

On the other hand, the location information processing unit 31a of the cloud 30 can acquire the location information from the photographer terminal 21 of each photographer 20 who is activating the photographing dedicated application 22 and perform processing for matching the service user 10 and the specific photographer 20.

The map information processing unit 31b of the cloud 30 stores in advance a database including a road map of an area in which the user vehicle 11 may travel. The matching processing unit 31 can transmit data of a road map of an area including a point where the user vehicle 11 is traveling and a point where each photographer 20 is present, and the position information of each photographer 20 to the service dedicated application 13 of the user terminal 12. Further, the matching processing unit 31 can transmit information on the service user 10 side such as the current position of the user vehicle 11 to the photographing dedicated application 22 of the photographer terminal 21 as necessary.

### <Operation of Vehicle Control System>

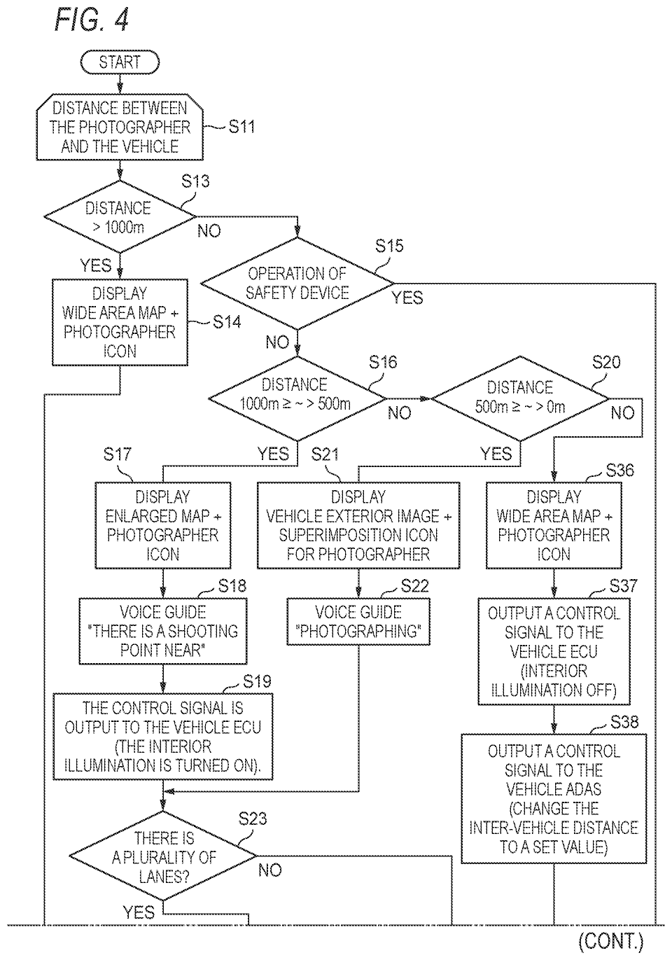

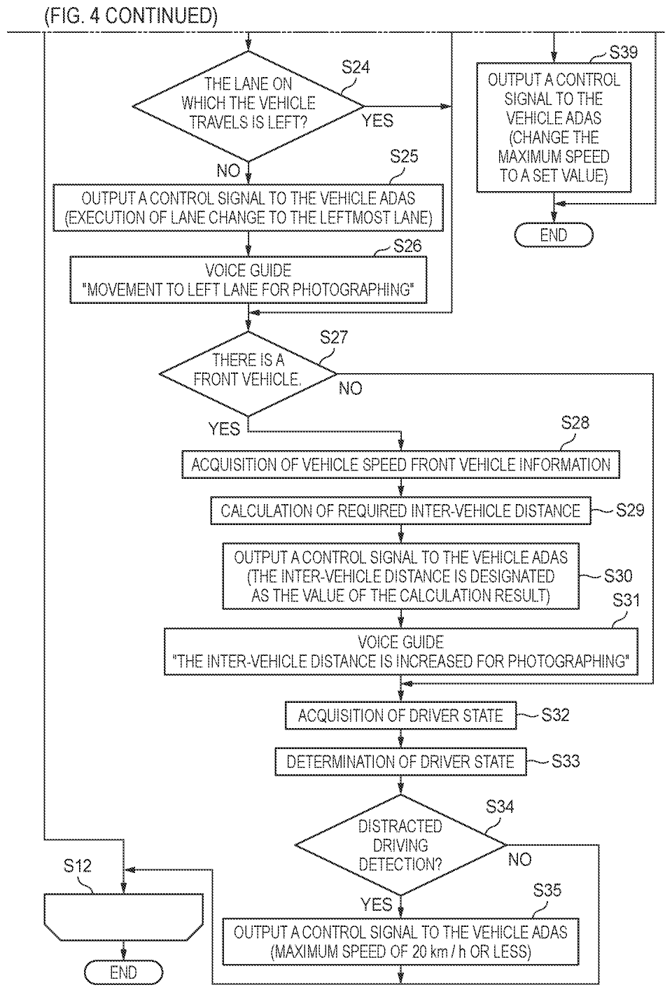

FIG. 4 shows an operation example of the vehicle control system in the photography management system 100. An operation of the vehicle control system shown in FIG. 4 will be described below.

When the service user 10 issues the request for photo taking with the service dedicated application 13, the cloud 30 executes control shown in FIG. 4. Further, the service dedicated application 13 or the matching processing unit 31 repeatedly acquires latest position information of the photographer 20 and the user vehicle 11 between S11 and S12 to constantly monitor the distance therebetween.

The service dedicated application 13 or the matching processing unit 31 switches a content of the processing according to a latest distance. In the example shown in FIG. 4, when the distance exceeds 1,000 m, the service dedicated application 13 or the matching processing unit 31 proceeds from S13 to S14.

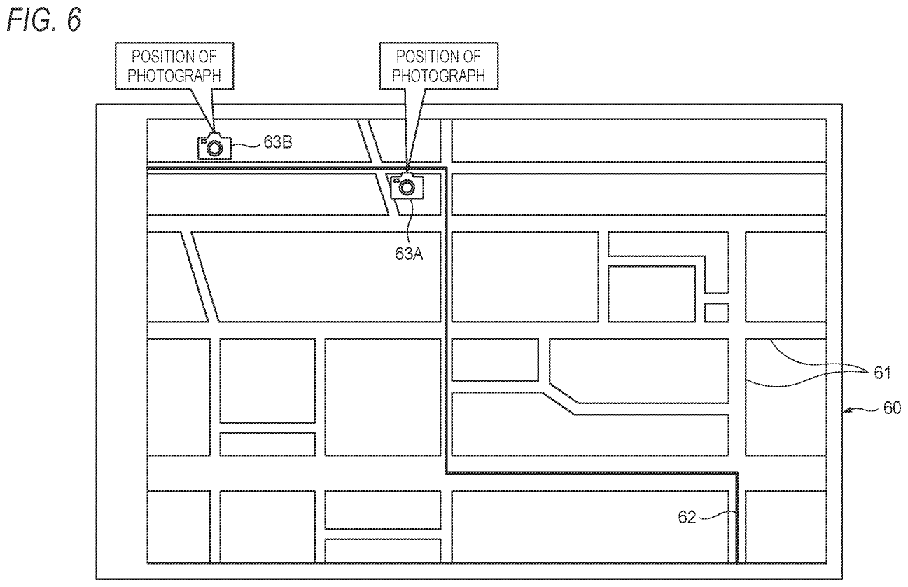

In this case, the service dedicated application 13 displays, on a screen of the display unit 12c, a road map of a relatively wide area in which the location of the matched photographer 20 is mapped as indicated by an icon mark (S14). Accordingly, for example, a screen as shown in FIG. 6 is displayed. By viewing a content of the screen, the service user 10 in the user vehicle 11 can grasp an approximate positional relationship between the own vehicle and the photographer 20.

When the distance becomes 1,000 m or less, the service dedicated application 13 or the matching processing unit 31 proceeds from S13 to S15, and identifies whether a safety device is operated in the own vehicle (user vehicle 11).

For example, when the user vehicle 11 is equipped with a system that monitors a behavior of the driver by photographing a face of the driver or the like with a camera, the system is used as the safety device. That is, when it is determined that the driver frequently checks surroundings from a face direction and a movement frequency of a line of sight of the service user 10 as the driver, the service dedicated application 13 or the matching processing unit 31 ends the operation shown in FIG. 4 in S15 and performs vehicle control for safe driving. Specifically, acceleration prevention control for the safe driving and power steering control (increasing a weight) are performed. However, when actions of the driver of stepping on the accelerator/turning a steering wheel forcefully are detected, the service dedicated application 13 or the matching processing unit 31 cancels the vehicle control on the assumption that the driver intends to cancel the vehicle control. Further, when a dangerous situation is predicted from road traffic conditions around the own vehicle, the safety device is also operated to stop control for photo taking.

When the distance is 1,000 m or less and the safety device does not operate, the service dedicated application 13 or the matching processing unit 31 further switches the content of the processing according to a range of the distance. For example, when the distance exceeds 500 m, the service dedicated application 13 or the matching processing unit 31 proceeds from S16 to S17, and when the distance is within a range of more than 0 m and less than 500 m, the service dedicated application 13 or the matching processing unit 31 proceeds from S20 to S21. Further, when the own vehicle has passed the position of the photographer 20, the service dedicated application 13 or the matching processing unit 31 proceeds from S20 to S36.

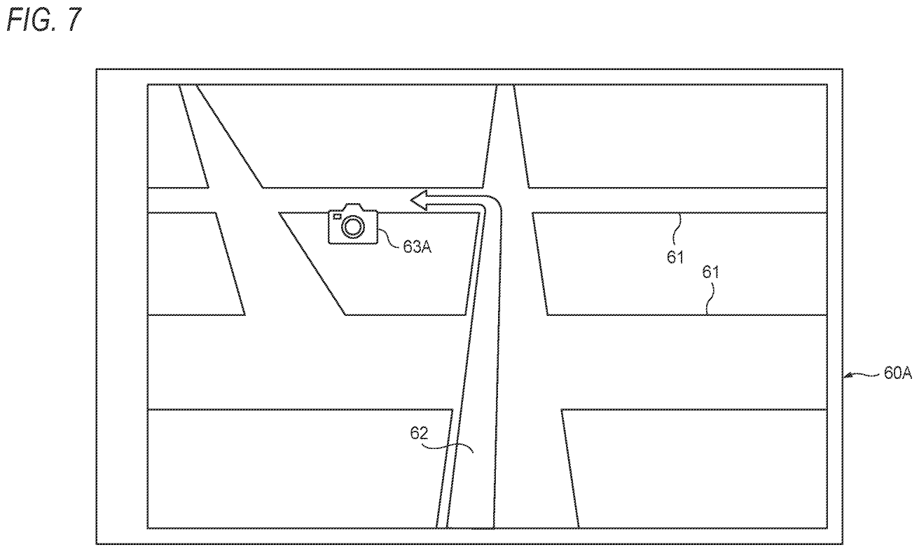

When the distance is within a range of 500 m to 1,000 m, the service dedicated application 13 or the matching processing unit 31 switches a scale of the map screen on which the position of the photographer 20 is mapped to an enlarged state for display (S17). Accordingly, for example, a screen as shown in FIG. 7 is displayed.

Further, the service dedicated application 13 or the matching processing unit 31 outputs, from the sound output unit 12d, the sound guidance such as “there is photographing point nearby”, and notifies the service user 10 that the position of the photographer 20 is near (S18).

Further, the service dedicated application 13 or the matching processing unit 31 automatically controls vehicle interior lighting of the user vehicle 11 in order to easily take the photo of the service user 10 in the user vehicle 11 (S19). That is, the service dedicated application 13 outputs the vehicle control signal to the light control unit 11d, and controls the light device of the lighting unit 11e to turn on.

Normally, illuminance inside the user vehicle 11 is lower than that outside the vehicle, so a photo of an interior scene is hardly taken, but by turning on the interior lighting of the user vehicle 11, the service user 10 can be photographed in a state in which the service user 10 appears brightly in the photo.

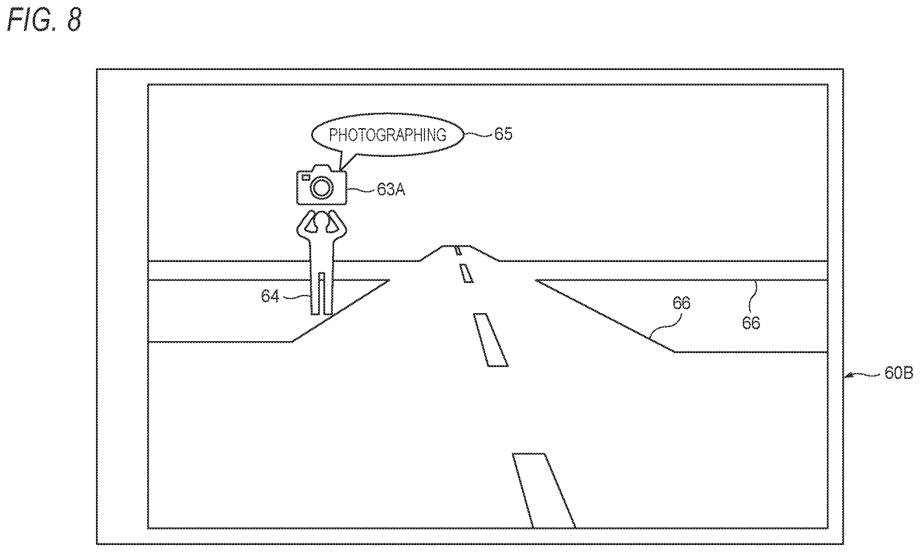

In a case in which the distance is in a range of 0 m to 500 m, the service dedicated application 13 or the matching processing unit 31 outputs, to the screen of the display unit 12c, an image in a state in which a real-time vehicle exterior video captured by the photographing unit 12a and an icon indicating the position of the photographer 20 are superimposed on each other (S21). Accordingly, for example, a screen as shown in FIG. 8 is displayed.

Further, the service dedicated application 13 or the matching processing unit 31 outputs, from the sound output unit 12d, the sound guidance such as “photograph”, and notifies the service user 10 that the photographer 20 is scheduled to take a photo soon (S22).

For example, the service dedicated application 13 can detect another vehicle present in front of the own vehicle as the preceding vehicle or can grasp the inter-vehicle distance between the own vehicle and the preceding vehicle by performing image processing on a content of the vehicle exterior video captured by the photographing unit 12a. Similarly, the ADAS control unit 11b can detect the preceding vehicle based on the information detected by the vehicle exterior monitoring sensor 11c, or can grasp the inter-vehicle distance between the own vehicle and the preceding vehicle.

When the distance is in the range of 0 m to 1,000 m, the service dedicated application 13 or the matching processing unit 31 determines whether a road on which the own vehicle is traveling has a plurality of lanes on one side by performing, for example, the image processing on the content of the vehicle exterior video captured by the photographing unit 12a (S23), and when there are the plurality of lanes, determines whether the own vehicle is traveling on a leftmost lane (S24). When the own vehicle is traveling in a lane other than the leftmost lane, a signal of a request for changing the lane to the leftmost lane is given to the ADAS control unit 11b to automatically control the vehicle (S25). Further, the service dedicated application 13 or the matching processing unit 31 outputs the sound guidance such as “move to left lane for photographing” through the sound output unit 12d (S26). When one side of the road is one lane or the own vehicle is traveling in the leftmost lane, the service dedicated application 13 or the matching processing unit 31 proceeds to S27.

Next, the service dedicated application 13 or the matching processing unit 31 identifies the presence or absence of the preceding vehicle in S27, and proceeds to S28 when the preceding vehicle is present. Further, the service dedicated application 13 or the matching processing unit 31 acquires the traveling speed of the own vehicle and the information of the preceding vehicle in S28, and calculates a necessary inter-vehicle distance in S29.

Further, the service dedicated application 13 or the matching processing unit 31 provides the signal of the inter-vehicle request to the ADAS control unit 11b to automatically control the vehicle (S30). That is, based on a current vehicle speed of the own vehicle, a speed of the own vehicle is controlled by automatically controlling the accelerator and the brake so that the preceding vehicle does not appear in the photo as the photographic subject when the photographer 20 takes the photo and the safe inter-vehicle distance is maintained between the preceding vehicle and the user vehicle 11.

The service dedicated application 13 or the matching processing unit 31 provides the sound output unit 12d with a signal of the sound guidance such as “inter-vehicle distance is increased for photographing” (S31). Accordingly, the service user 10 in the own vehicle as the driver or another passenger can know that the own vehicle is scheduled to automatically adjust the inter-vehicle distance for photographing.

On the other hand, a driver monitoring system (not shown) mounted on the user vehicle 11 acquires information indicating a driving state of the driver based on an image of the face of the driver captured by a camera in the vehicle (S32). Further, the driver monitoring system grasps the presence or absence of abnormality such as inattentive driving in the driving state of the driver (S33).

When the driver monitoring system detects the behavior of the driver such as inattentive driving, the service dedicated application 13 or the matching processing unit 31 proceeds from S34 to S35. Further, a control signal is output to the ADAS control unit 11b in order to ensure safety of the driving. Specifically, the control signal instructs to limit the maximum traveling speed of the user vehicle 11 to, for example, 20 km/h or less.

On the other hand, when the distance is less than 0 m, that is, when the own vehicle passes the position of the photographer 20, the service dedicated application 13 or the matching processing unit 31 displays, on the screen of the display unit 12c, the road map of the relatively wide area in which the location of the photographer 20 is mapped as indicated by the icon mark (S36).

The service dedicated application 13 or the matching processing unit 31 outputs the vehicle control signal to the light control unit 11d to automatically control the interior lighting of the lighting unit 11e to turn off (S37). Further, the service dedicated application 13 or the matching processing unit 31 outputs the signal of the inter-vehicle request to the ADAS control unit 11b, and performs control such that a reference value of the inter-vehicle distance between the own vehicle and the preceding vehicle returns to a set value during normal driving (S38). Further, the service dedicated application 13 or the matching processing unit 31 outputs an instruction to change the speed to the ADAS control unit 11b, and performs control such that the reference value of the maximum speed of the own vehicle returns to the set value during normal driving (S39).

### <Modification of Operation>

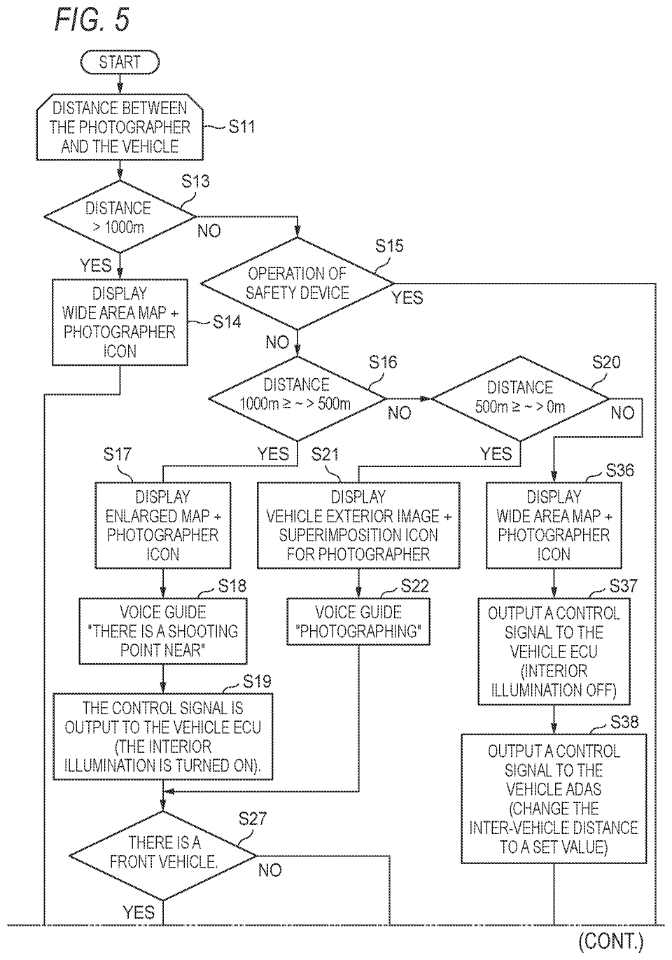

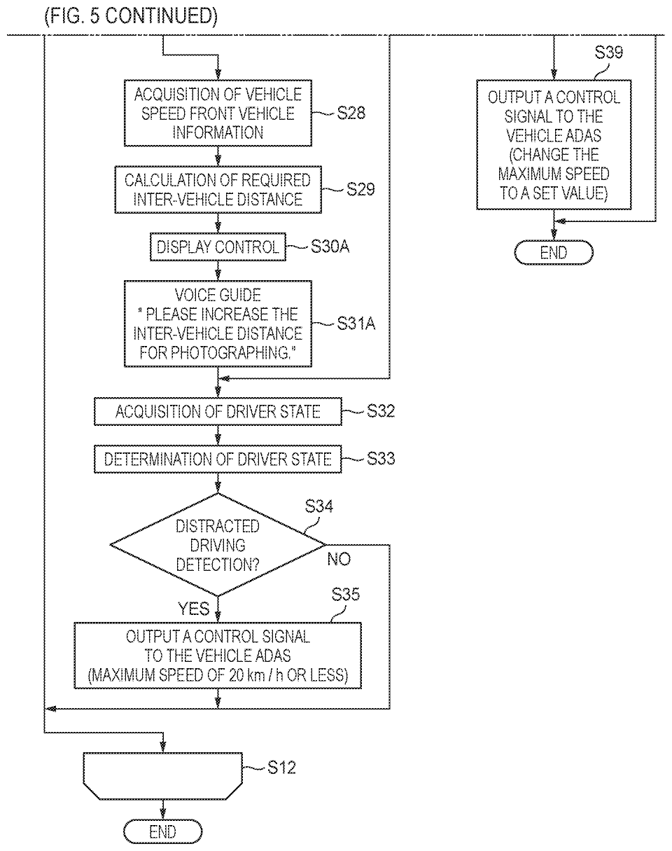

FIG. 5 shows an operation of a vehicle control system according to a modification. In the operation shown in FIG. 5, processes of steps S30A and S31A are changed. The same step numbers are assigned to the same processes as those in FIG. 4. Changes in FIG. 5 will be described below.

When a preceding vehicle is present in front of the user vehicle 11, the service dedicated application 13 or the matching processing unit 31 notifies, by a screen display of the display unit 12c, a driver of the user vehicle 11 that it is necessary to increase an inter-vehicle distance between an own vehicle and the preceding vehicle for photographing (S30A).

Further, the service dedicated application 13 or the matching processing unit 31 outputs, by the sound output unit 12d, sound guidance such as “please widen inter-vehicle distance for photographing”, and notifies the driver that a driving operation of widening the inter-vehicle distance is necessary (S31A).

Although steps S23 to S26 shown in FIG. 4 are omitted in the modification of FIG. 5, processes of S23 and S24 may be executed, and when the service dedicated application 13 or the matching processing unit 31 determines that the own vehicle is not traveling on the leftmost lane, the audio guidance such as “please move to left lane for photographing” may be issued.

### Screen Display Example 1

FIG. 6 shows a screen display example 1 on a service user side.

After the service user 10 transmits a photo taking request to the cloud 30 of the photography management system 100, when the distance between the position of the user vehicle 11 and the position of each photographer 20 is greater than 1 km, a display screen 60 as shown in FIG. 6 is displayed on the display unit 12c in the process of S14 shown in FIG. 4, for example.

In the display screen 60 shown in FIG. 6, a road map 61 of a relatively wide area, a scheduled travel route 62 of the user vehicle 11, and photographer marks (camera icons) 63A and 63B representing positions of the respective photographers 20 present in the vicinity of the scheduled travel route are displayed in an overlapping manner.

Information of the road map 61 displayed on the display screen 60 can be specified based on a database of a road map usable by the cloud 30 and the current position of the user vehicle 11. Further, the location information of each photographer 20 can be acquired through communication between the cloud 30 and the photographing dedicated application 22.

Accordingly, the service user 10 driving the user vehicle 11 can more easily grasp, by the display screen 60 as shown in FIG. 6, the approximate positional relationship between the own vehicle and each photographer 20.

### Screen Display Example 2

FIG. 7 shows a screen display example 2 on the service user side.

When the distance between the position of the user vehicle 11 and the position of each photographer 20 is within the range of 500 m to 1,000 m, for example, a display screen 60A as shown in FIG. 7 is displayed on the display unit 12c in the process of S17 shown in FIG. 4.

In the display screen 60A shown in FIG. 7, the road map 61 of a narrow area in a state in which a scale of the map is enlarged, the scheduled traveling route 62 of the user vehicle 11, and the photographer mark 63A representing the position of the photographer 20 present in the vicinity of the scheduled traveling route are displayed in an overlapping manner.

Accordingly, the service user 10 driving the user vehicle 11 can more easily grasp, by the display screen 60A as shown in FIG. 7, the positional relationship between the own vehicle and each photographer 20.

### Screen Display Example 3

FIG. 8 shows a screen display example 3 on the service user side.

When the distance between the position of the user vehicle 11 and the position of each photographer 20 is within the range of 0 m to 500 m, for example, a display screen 60B as shown in FIG. 8 is displayed on the display unit 12c in the process of S21 shown in FIG. 4.

In the display screen 60B shown in FIG. 8, a real-time vehicle exterior video 66 captured by the photographing unit 12a, the photographer marks 63A and 64 indicating the positions of the photographers 20, and a photographing notice mark 65 are displayed in an overlapping manner.

Therefore, the service user 10 driving the user vehicle 11 can more easily grasp, by the display screen 60B as shown in FIG. 8, a position where the camera that takes the photo is present and a direction of the camera. Further, it is also possible to grasp that the photographing timing is reached soon.

As described above, by using the photography management system 100 according to the present embodiment, the service user 10 who is in the user vehicle 11 and moving can transmit, to the cloud 30, the request for photo taking. Since the cloud 30 performs matching between the appropriate photographer 20 and the service user 10, the service user 10 and the user vehicle 11 can be photographed by the camera of the photographer 20 during the traveling.

In addition, by providing the vehicle control system that issues the instruction to reduce the speed of the own vehicle or the instruction to change the lane to the leftmost lane according to the vehicle situation of the own vehicle or the surrounding vehicle situation when the user vehicle 11 reaches the vicinity of the photographing point, the appropriate photo can be easily taken. Further, by the cooperation between the ADAS control unit 11b and the driver monitoring system mounted on the user vehicle 11, it is easy to ensure the safety during the driving.

In particular, when another preceding vehicle is present in front of the user vehicle 11, the photography management system 100 issues an instruction to increase the inter-vehicle distance between the user vehicle 11 and the preceding vehicle, and thus it is possible to avoid the preceding vehicle from appearing in the taken photo, and a high-quality photo is easily taken.

The present invention is not limited to the embodiment described above and can be appropriately modified, improved and the like. In addition, materials, shapes, sizes, numbers, arrangement positions and the like of components in the embodiments described above are freely selected and are not limited as long as the present invention can be implemented.

For example, in the above-described embodiment, the service dedicated application 13 or the matching processing unit 31 gives the signal of the request for changing the lane to the leftmost lane to the ADAS control unit 11b when the own vehicle is traveling in a lane other than the leftmost lane, but in countries where vehicles drive on the right side of the road, the service dedicated application 13 or the matching processing unit 31 requests for changing the lane to the rightmost lane.

Here, the features of the vehicle control system and the vehicle control method according to the embodiments of the present invention described above are briefly summarized and listed in the following [1] to [6]. [1] A vehicle control system (photography management system 100) including:
a communication control unit (cloud 30) configured to control cooperation between a first communication terminal (user terminal 12) used by a specific person having a desire of being photographed (service user 10) who is movable using a vehicle and a second communication terminal (photographer terminal 21) used by a photographer who is capable of photograph the person having a desire of being photographed with a camera; and
a vehicle control unit (service dedicated application 13) configured to control a specific vehicle (user vehicle 11) associated with the person having a desire of being photographed, wherein
the vehicle control unit has a traveling state changing function (information control unit 13a, S23 to S35) configured to generate an instruction to change a traveling state of an own vehicle to a traveling state that is easy for the photographer to see at least when the own vehicle approaches a photographing position of the photographer.

According to the vehicle control system having the configuration of the above [1], when the photographer photographs the vehicle as the photographing object, the traveling speed of the vehicle is reduced or the lane is changed and the vehicle is moved to the position where the vehicle is easily seen by the photographer, and thus the photographer can easily perform appropriate operations such as adjustment of a photographic timing, positioning of a camera, and focusing. Accordingly, the high-quality photo is easily taken. Further, if the vehicle speed is reduced, a safe driving state can be maintained even at the time of taking the photo.

[2] The vehicle control system according to [1], wherein
the traveling state changing function automatically prevents a traveling speed of the own vehicle by limiting an accelerator operation of the own vehicle or by applying a braking operation in accordance with a situation of the own vehicle or a situation around the own vehicle (S30, S35).

According to the vehicle control system having the configuration of the [2], since the vehicle automatically controls the speed at the time of photographing, the driver is not required to perform a special driving operation for the photographing. Therefore, even when the person having a desire of being photographed is the driver, the person having a desire of being photographed can easily align the direction of the face or the line of sight to the camera position of the photographer at the photographing position.

[3] The vehicle control system according to the [1] or the [2], wherein
the traveling state changing function changes a lane of the own vehicle to a lane that is easy for the photographer to see at least when the own vehicle approaches the photographing position of the photographer (S25).

According to the vehicle control system having the configuration of the [3], since the vehicle automatically changes a travel lane at the time of the photographing, the driver is not required to perform a special driving operation for the photographing. Therefore, even when the person having a desire of being photographed is the driver, the person having a desire of being photographed can easily align the direction of the face or the line of sight to the camera position of the photographer at the photographing position.

[4] The vehicle control system according to the [1], wherein
when a predetermined condition is satisfied, the traveling state changing function guides a driver of the own vehicle in a driving operation to reduce the traveling speed by using at least one of a display and a sound output (S30A).

According to the vehicle control system having the configuration of the [4], the driver can adjust the own vehicle to the traveling state suitable for the photographing only by performing the driving operation to reduce the traveling speed according to the guidance of the system. Accordingly, the high-quality photo is easily taken.

[5] The vehicle control system according to the above [1], wherein
the traveling state changing function generates an instruction to increase an inter-vehicle distance between the own vehicle and a preceding vehicle when the preceding vehicle is present in front of the own vehicle (S27 to S30).

According to the vehicle control system having the configuration of the above [5], when the photographer photographs the vehicle of the person wishing image capture, it is possible to prevent the preceding vehicle from being captured in the photograph together with the vehicle of the person wishing image capture. This makes it easy to take a high-quality photograph.

[6] A vehicle control method includes: securing a communication path so that a first communication terminal used by a specific person who can move using a vehicle and a second communication terminal used by a photographer who can photograph the person with a camera can cooperate with each other (operation of a cloud 30); grasping a positional relationship between an own vehicle and a photographing position of the photographer (S11); and generating an instruction to change the own vehicle to a traveling state in which the own vehicle is easily seen by the photographer when the own vehicle approaches the photographing position of the photographer (S25, S30, S35).

According to the vehicle control method of the procedure of [6], when the photographer photographs the vehicle to be photographed, the traveling speed of the vehicle is prevented or the lane is changed and the vehicle is moved to a position easy to see from the photographer. This makes it easy to take a high-quality photograph. Further, if the vehicle speed is prevented, a safe driving state can be maintained even at the time of photographing.

What is claimed is:

1. A vehicle control system comprising:
a communication control unit that controls cooperation between a first communication terminal used by a specific person who is capable of moving by using a vehicle and a second communication terminal used by a photographer who is capable of photographing the specific person with a camera; and
a vehicle control unit that controls a specific vehicle associated with the specific person,
wherein the vehicle control unit has a traveling state changing function of generating an instruction for changing a traveling state of a subject vehicle to a traveling state that is easy to see from the photographer when the subject vehicle approaches a photographing position of the photographer.

2. The vehicle control system according to claim 1,
wherein the traveling state changing function automatically prevents the traveling speed of the subject vehicle by limiting accelerator operation of the subject vehicle or by braking the subject vehicle in accordance with a situation of the subject vehicle or a situation around the subject vehicle.

3. The vehicle control system according to claim 1,
wherein the traveling state changing function changes a lane of the subject vehicle to a lane that is easy for the photographer to see when the subject vehicle approaches the photographing position of the photographer at least.

4. The vehicle control system according to claim 1,
wherein, when a predetermined condition is satisfied, the traveling state changing function guides a driver of the subject vehicle to perform a driving operation for reducing a traveling speed by using at least one of a display and a sound output.

5. The vehicle control system according to claim 1,
wherein the traveling state changing function generates an instruction for increasing an inter-vehicle distance between the subject vehicle and a preceding vehicle when the preceding vehicle is present in front of the subject vehicle.

6. A vehicle control method comprising:
securing a communication path so as to enable cooperation between a first communication terminal used by a specific person who can move by using a vehicle and a second communication terminal used by a photographer who can photograph the specific person with a camera;
grasping a positional relationship between a subject vehicle and a photographing position of the photographer; and
generating an instruction to change the subject vehicle to a traveling state easy to see from the photographer when the subject vehicle approaches the photographing position of the photographer.

7. A vehicle control device comprising:
a memory storing instructions; and
a processor that implements the instructions to
acquire a communication path so as to enable cooperation between a first communication terminal used by a specific person and a second communication terminal used by a photographer who can photograph the specific person with a camera;
obtain a positional relationship between a subject vehicle and a photographing position of the photographer; and
change the subject vehicle to a traveling state easy to see from the photographer when the subject vehicle approaches the photographing position of the photographer.
